(19) United States
(12) Patent Application Publication
(10) Pub. No.: US 2017/0067288 A1
(43) Pub. Date: Mar. 9, 2017

(54) CONTROL MODULE OF CORDLESS WINDOW COVERING

(71) Applicant: NIEN MADE ENTERPRISE CO., LTD., Taichung City (TW)

(72) Inventors: Chao-Hung NIEN, Taichung City (TW); Chih-Yao CHANG, Taichung (TW)

(21) Appl. No.: 15/231,459

(22) Filed: Aug. 8, 2016

(30) Foreign Application Priority Data
Sep. 8, 2015 (CN) 201520689958.6

(51) Int. Cl. E06B 9/322; E06B 9/326; E06B 9/303

(52) U.S. Cl. CPC E06B 9/322; E06B 9/303; E06B 9/326; E06B 2009/3222; E06B 2009/3225

(57) ABSTRACT

A control module of a cordless window covering is disclosed, wherein a first prestressing device and a second prestressing device are provided on two lateral sides of a reel which is adapted to be wound around by lifting cords. In the condition that one single reel is wound around by two lifting cords, the number of gears linked to be rotated together could be reduced. In the condition that the control module is applied to a large window covering which has odd numbers of lifting cords, the pulling force provided by the first prestressing device and the second prestressing device could be distributed evenly on the reel, and the control module could effectively withstand the loadings of the lifting cords, which prevents the window covering from tilting, or prevents the problem that the springs are insufficient to bear the loadings.

### BACKGROUND OF THE INVENTION

1. Technical Field

The present invention relates generally to the structure of a window covering, and more particularly to a control module of a cordless window covering.

2. Description of Related Art

A conventional cordless window covering is usually provided with an automatic reeling device in the headrail. The automatic reeling device has at least one reel, of which the number corresponds to the number of the lifting cords provided to the window covering. Generally, a cordless window covering includes at least two lifting cords. The automatic reeling device may wind up or release the lifting cords when the bottom rail is lifted or lowered, so as to raise or drop the cordless window covering.

The relation between an automatic reeling device and lifting cords of a cordless window covering is disclosed in the U.S. Pat. No. 6,289,965, titled “Take-up drum for a cordless shade counterbalance”. The automatic reeling device disclosed therein includes a prestressing device and two reels provided on two lateral sides of the prestressing device. Each of the reels is connected to a lifting cord. The prestressing device includes two drums and a spiral spring, wherein each end of the spiral spring is respectively connected to one of the drums to provide an average tension, making a bottom rail stop at a desired position. A gear is provided on one end of each drum and each reel, which makes the drums and the reels linked to rotate together.

However, in said patent, the arrangement of the prestressing device and the reels requires four gears to smoothly wind up or release the lifting cords. It is well known that, with more gears, more energy would be lost during transmission, which may affect the precise positioning of the bottom rail.

Furthermore, since the prestressing device is located in the middle, the reels would be provided in an unsymmetrical distribution, with odd numbers of reels on one side and even numbers of reels on the other side, if said disclosure is applied to a large window covering with odd numbers of lifting cords. The unsymmetrical distribution leads to uneven force on the reels. In addition, the prestressing device includes only one spiral spring, of which the low driving torque would not be able to withstand the loadings of the lifting cords, which might make the winding of the lifting cords unsmooth. Though this problem could be improved by further providing another prestressing device, such arrangement would require more gears, leading to more significant energy loss.

### BRIEF SUMMARY OF THE INVENTION

In view of the above, the primary objective of the present invention is to provide a control module of a cordless window covering, which may reduce the number of the gears, and ensure that the reel could roll smoothly.

The present invention provides a control module of a cordless window covering, wherein the control module includes a base, a first prestressing device, a second prestressing device, and at least one reel. The first prestressing device is provided on the base, wherein the first prestressing device includes two first drums and a first spiral spring; each end of the first spiral spring is respectively connected to one of the first drums; one of the first drums has a first gear. The second prestressing device is provided on the base, wherein the second prestressing device includes two second drums and a second spiral spring; each end of the second spiral spring is respectively connected to one of the second drums; one of the second drums has a second gear. The at least one reel is provided on the base, wherein the at least one reel is adapted to be wound by at least one lifting cord; the at least one reel is located between the first prestressing device and the second prestressing device, and each of the at least one reel includes at least one intermediate gear; the first gear of the first prestressing device and the second gear of the second prestressing device are linked to rotate together through the at least one intermediate gear of the at least one reel.

In an embodiment, each of the at least one reel has a spool, and one end of the spool is connected to one of the at least one intermediate gear; the spool is divided into an upper reeling segment and a lower reeling segment; the at least one lifting cord includes a first lifting cord and a second lifting cord; one end of the first lifting cord is connected to the upper reeling segment, while one end of the second lifting cord is connected to the lower reeling segment.

In an embodiment, the at least one reel includes a first reel and a second reel; the first reel includes a first spool and a first intermediate gear connected to one end of the first spool; the second reel includes a second spool and a second intermediate gear connected to one end of the second spool; the at least one lifting cord includes a first lifting cord and a second lifting cord; one end of the first lifting cord is connected to the first spool, while one end of the second lifting cord is connected to the second spool; the first gear of the first prestressing device meshes with the first intermediate gear, while the second gear of the second prestressing device meshes with the second intermediate gear, whereby the first intermediate gear and the second intermediate gear are synchronously rotatable.

In an embodiment, an intermediate wheel is provided between the first reel and the second reel, wherein the intermediate wheel meshes with the first reel and the second reel, whereby the intermediate wheel, the first reel, and the second reel are linked to rotate together.

In an embodiment, a plurality of fixing posts are provided on the base, which are adapted to be rotatably fitted around by the first drums, the second drums, and the at least one reel; a plurality of guiding posts are further provided on the base for determining a moving direction of each of the at least one lifting cord by being abutted against by the at least one lifting cord; the first prestressing device includes a first sleeve, which rotatably fits between one of the first drums and one of the fixing posts; the second prestressing device includes a second sleeve, which rotatably fits between one of the second drums and one of the fixing posts.

In an embodiment, when in a normal condition, most of the first spiral spring of the first prestressing device winds around the first drum which does not have the first gear, and the first sleeve is provided between said first drum and one of the fixing posts; also in the normal condition, most of the second spiral spring of the second prestressing device winds around the second drum which does not have the second gear, and the second sleeve is provided between said second drum and one of the fixing posts.

In an embodiment, the base is long and has a certain length; the first prestressing device and the second prestressing device are respectively located on two lateral sides of the base in parallel to a long side of the base; the first drums and the second drums are arranged substantially in parallel to the long side of the base; the first gear and the second gear respectively belong to the first drum and the second drum which are close to each other on the base, and each of which is synchronously rotatable with the relevant first drum or the relevant second drum.

In an embodiment, the control module is arranged with at least one another control module; two control modules among the control module and the at least one another control module are connected through a connector; the connector is connected to any rotatable component, which has a gear, of each of said two control modules.

In an embodiment, the connector is a connecting cord.

By providing the first prestressing device and the second prestressing device on two sides of the reel, the reel could roll smoothly. The number of the gears could be reduced, for one single reel could wind up two lifting cords. When applied to the cordless window covering equipped with odd numbers of lifting cords, the pulling force could evenly distribute on the reels since the first prestressing device and the second prestressing device are symmetrically provided on two sides of the reel, which could effectively withstand the loadings of the lifting cords.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the cordless window covering which has the control module of a first embodiment of the present invention;

FIG. 2 is a perspective view, showing the control module of the first embodiment of the present invention;

FIG. 3 is a top view, showing the control module of the first embodiment of the present invention;

FIG. 4 is a partial side view of the first embodiment of the present invention, showing the lifting cords are wound around the reel;

FIG. 5 is a top view similar to FIG. 3, showing the spiral springs wind around a different position;

FIG. 6 is a partial side view similar to FIG. 4, showing the lifting cords are released from the reel;

FIG. 7 is a top view, showing the control module of a second embodiment of the present invention;

FIG. 8 is a partial side view of the second embodiment of the present invention, showing each of the reels respectively has a lifting cord wound around;

FIG. 9 is a top view, showing the control module of a third embodiment of the present invention;

FIG. 10 is a top view, showing the control module of a fourth embodiment of the present invention;

FIG. 11 is a perspective view of the present invention, showing the control module includes the sleeve; and

FIG. 12 is a top view of the present invention, showing two control modules are connected to each other in parallel through the connecting cord, and are provided in the headrail.

### DETAILED DESCRIPTION OF THE INVENTION

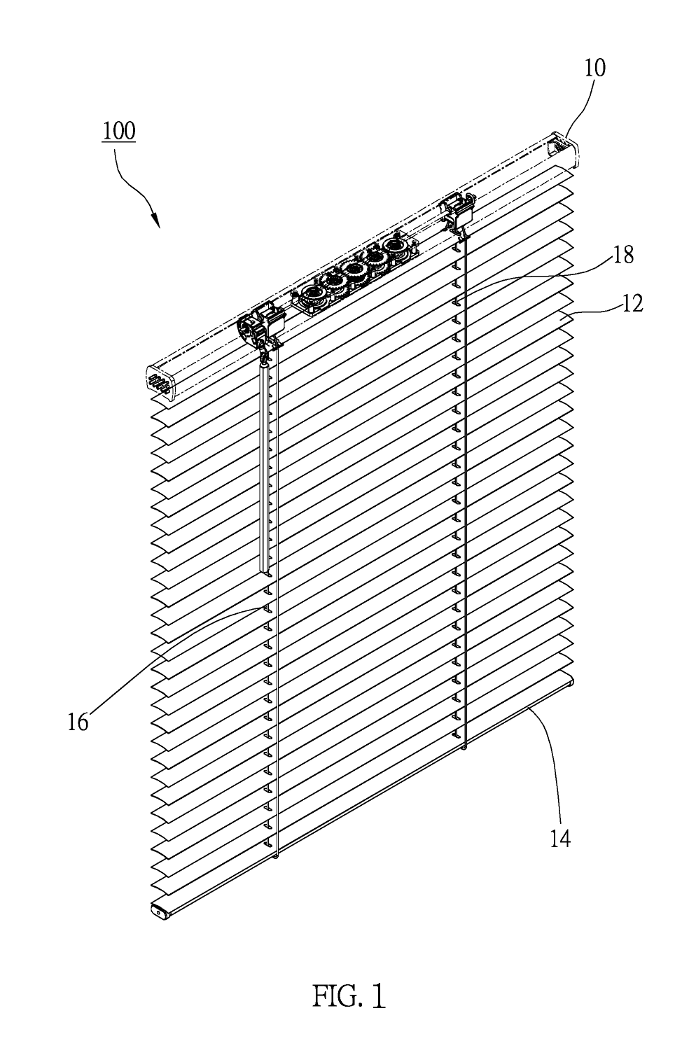

As shown in FIG. 1, a cordless window covering 100 applied with a control module of a first embodiment of the present invention includes a headrail 10, a shade structure 12, and a bottom rail 14, wherein the shade structure 12 includes a plurality of slats provided between the headrail 10 and the bottom rail 14. The cordless window covering 100 further includes a first lifting cord 16 and a second lifting cord 18, wherein an end of the first lifting cord 16 and an end of the second lifting cord 18 are connected to the bottom rail 14. Through the control module, the first lifting cord 16 and the second lifting cord 18 are controllable to lift or lower the bottom rail 14 relative to the headrail 10, so that the cordless window covering 100 can be raised or lowered in this way. The control module of the first embodiment is provided in the headrail 10.

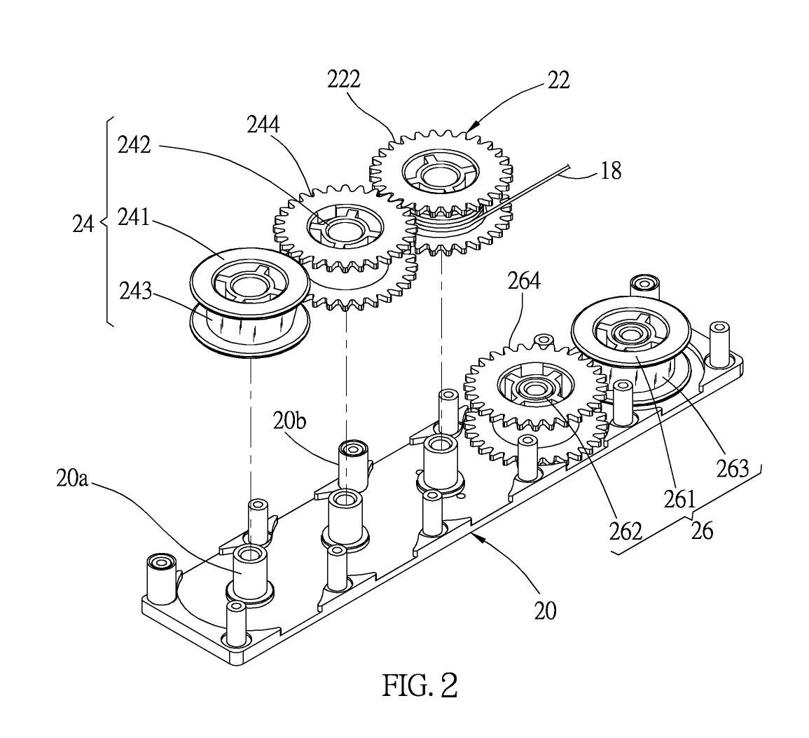

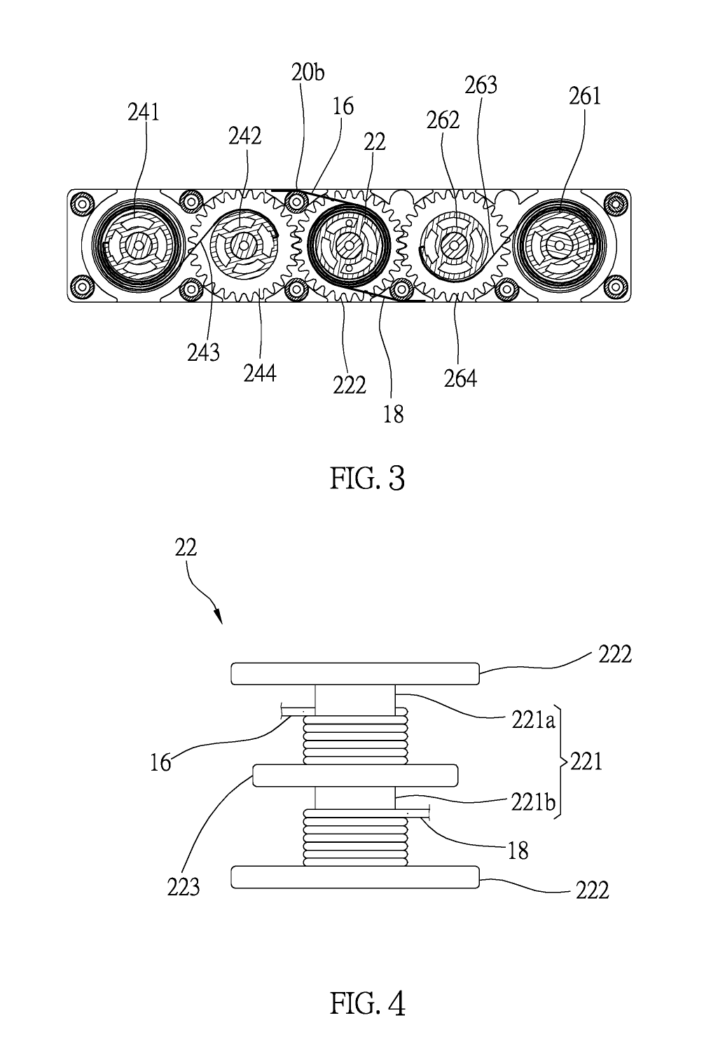

As shown in FIG. 2 and FIG. 3, the control module includes a base 20, which has a reel 22, a first prestressing device 24, and a second prestressing device 26 provided thereon. A top surface of the base 20 has a plurality of fixing posts 20a and a plurality of guiding posts 20b erected therefrom, wherein the reel 22 is rotatable, and fits around the fixing post 20a located in a middle position. The first prestressing device 24 and the second prestressing device 26 are respectively provided on two lateral sides of the reel 22.

As shown in FIG. 4, the reel 22 has a spool 221, wherein each end of the spool 221 is respectively connected to an intermediate gear 222, and a middle section of the spool 221 has a ridge 223. An upper reeling segment 221a and a lower reeling segment 221b are respectively formed between the ridge 223 and one of the intermediate gears 222, wherein another end of the first lifting cord 16 is connected to the upper reeling segment 221a, while another end of the second lifting cord 18 is connected to the lower reeling segment 221b. A moving direction of the first lifting cord 16 and of the second lifting cord 18 is respectively determined by being guided by (i.e., abutting against) the guiding posts 20b of the base 20. In the first embodiment, the moving directions of the first lifting cord 16 and the second lifting cord 18 are respectively substantially in parallel to a long side of the base 20.

The first prestressing device 24 includes two first drums 241, 242 and a first spiral spring 243. Each of the first drums 241, 242 is rotatable, and respectively fits around one of the fixing posts 20a. Each end of the first drum 242 is respectively connected to a first gear 244 meshing with one of the intermediate gears 222, so that the first drum 242 and the reel 22 are adapted to be rotated together. Each end of the first spiral spring 243 is respectively connected to one of the first drums 241, 242. As shown in FIG. 3, in a normal condition, most of the first spiral spring 243 winds around one of the first drums which is not connected to the first gear 244, i.e., the first drum 241. Said normal condition refers to the collapsed status of the cordless window covering 100, i.e., when the headrail 10 is close to the bottom rail 14.

The second prestressing device 26 includes two second drums 261, 262 and a second spiral spring 263. Each of the second drums 261, 262 is rotatable, and respectively fits around one of the fixing posts 20a. Each end of the second drum 262 is respectively connected to a second gear 264 meshing with one of the intermediate gears 222, so that the second drum 262 and the reel 22 are adapted to be rotated together. Each end of the second spiral spring 263 is connected to one of the second drums 261, 262. Again, in the normal condition, most of the second spiral spring 263 winds around one of the second drums which is not connected to the second gear 264, i.e., the second drum 261.

As described above, the first gears 244 of the first prestressing device 24 mesh with the intermediate gears 222, and the intermediate gears 222 mesh with the second gears 264 of the second prestressing device 26. In this way, the connected first drum 242, reel 22, and the second drum 262 are linked to be rotated together. The first spiral spring 243 would provide a rotational pulling force to the relevant first drum 242, and the second spiral spring 263 would provide a rotational pulling force to the relevant second drum 262. With such multiplied pulling force, the bottom rail 14 could be indeed held in a predetermine position when the cordless window covering 100 is in the normal condition. In other words, despite the weight of the slats stacked on the bottom rail 14, the bottom rail 14 could simply stop at the predetermined position. As shown in FIG. 4, at this time, most of the first lifting cord 16 winds around the upper reeling segment 221a, while most of the second lifting cord 18 winds around the lower reeling segment 221b.

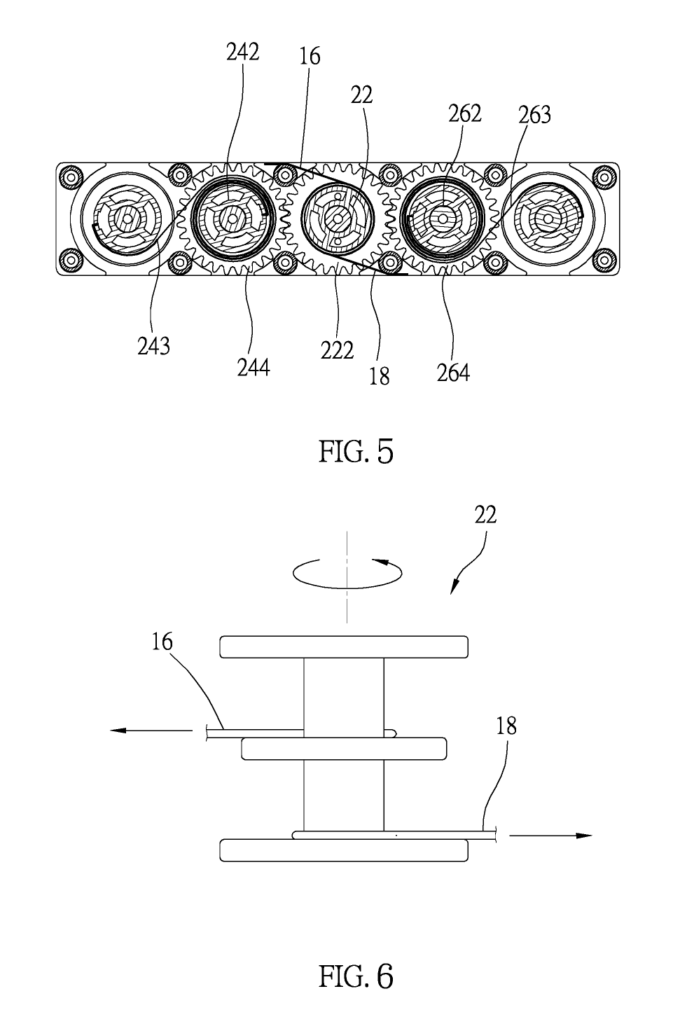

As shown in FIG. 5 and FIG. 6, while the bottom rail 14 is being pulled downward to unfold the cordless window covering 100, the first lifting cord 16 and the second lifting cord 18 are released from the reel 22, which makes the reel 22 rotate. The first drum 242, the second drum 262, and the reel 22 could be rotated together since the first drum 242 and the second drum 262 mesh with the reel 22. In such a condition, most of the first spiral spring 243 winds around the first drum 242 connected to the first gear 244, while most of the second spiral spring 263 winds around the second drum 262 connected to the second gear 264. While the bottom rail 14 is being raised to fold the cordless window covering 100, the first spiral spring 243 and the second spiral spring 263 provide a pulling force which could make it easier to lift the shade structure 12.

The first prestressing device 24 and the second prestressing device 26 are respectively provided on two lateral sides of the reel 22, and the reel 22 is connected to the first lifting cord 16 and the second lifting cord 18, whereby the bottom rail 14 of the cordless window covering 100 of the first embodiment could be lifted or lowered through only three gears (i.e. two corresponding sets of the prestressing device 24, 26, each set includes one of the first gears 244, one of the intermediate gears 222, and one of the second gears 264 which sequentially mesh together). Compare to the disclosure of the U.S. Pat. No. 6,289,965, the present invention could prevent excessive energy loss by reducing the number of the gears, which could ensure the pulling force to be evenly distributed on the reel 22, making the reel 22 rotate smoothly.

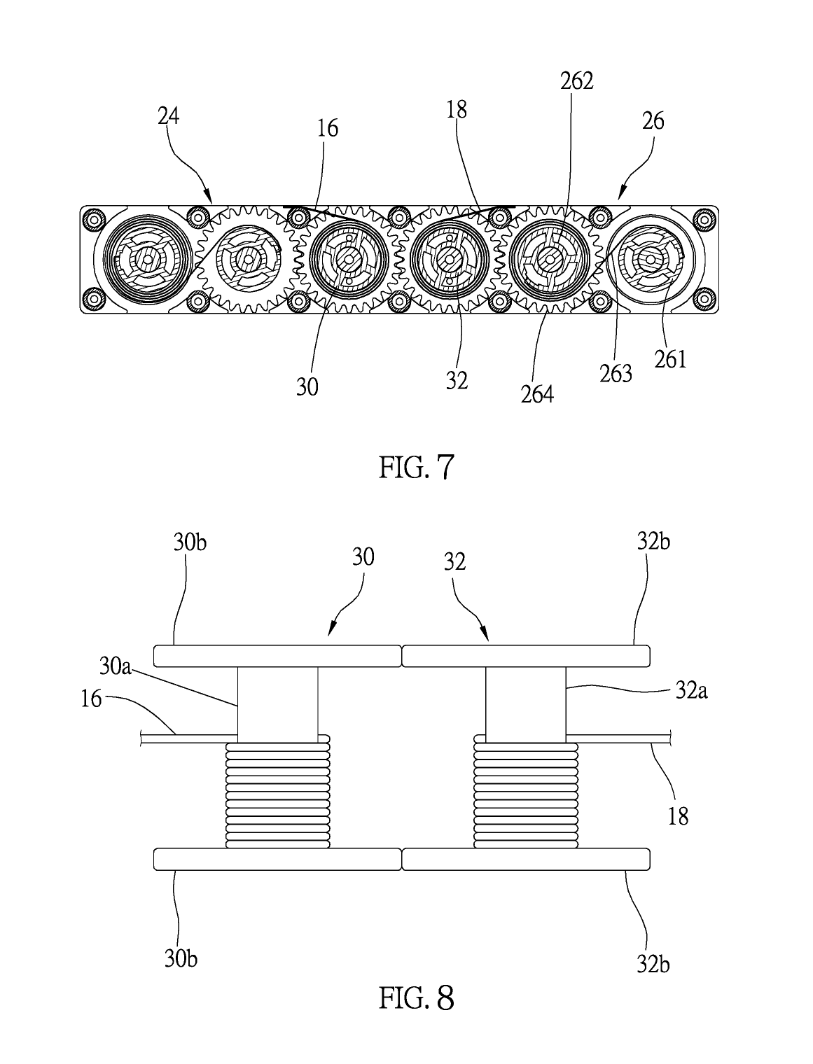

A control module of a second embodiment of the present invention is illustrated in FIG. 7, which is also compatible with a cordless window covering with two lifting cords (say, the first lifting cord 16 and the second lifting cord 18), and also includes said first prestressing device 24 and said second prestressing device 26. The difference between the control module of the first embodiment and that of the second embodiment is that, most of the second spiral spring 263 of the second prestressing device 26 winds around the second drum 262 connected to the second gear 264 in the normal condition. Furthermore, the control module of the second embodiment includes two reels, which are a first reel 30 and a second reel 32. As shown in FIG. 8, the first reel 30 has a first spool 30a, wherein each end of the first spool 30a is respectively connected to a first intermediate gear 30b; the second reel 32 has a second spool 32a, wherein each end of the second spool 30a is respectively connected to a second intermediate gear 32b.

One end of the first lifting cord 16 is connected to the first spool 30a, while one end of the second lifting cord 18 is connected to the second spool 32a.

Each of the first gears 244 of the first prestressing device 24 meshes with one of the first intermediate gears 30b, while each of the second gears 264 of the second prestressing device 26 meshes with one of the second intermediate gears 32b, whereby the first intermediate gears 30b and the second intermediate gears 32b are linked to be rotated together. With a specific way of winding the first lifting cord 16 and the second lifting cord 18, the first lifting cord 16 and the second lifting cord 18 could be wound up or released synchronously. Since the first prestressing device 24 and the second prestressing device 26 are respectively provided on two lateral sides of the reels 30, 32, and each of the reels respectively provides a pulling force to one of the reels 30, 32, the reels 30, 32 could be rotated smoothly, and the pulling force could be ensured to be distributed evenly, despite the fact that the control module of the second embodiment uses four gears.

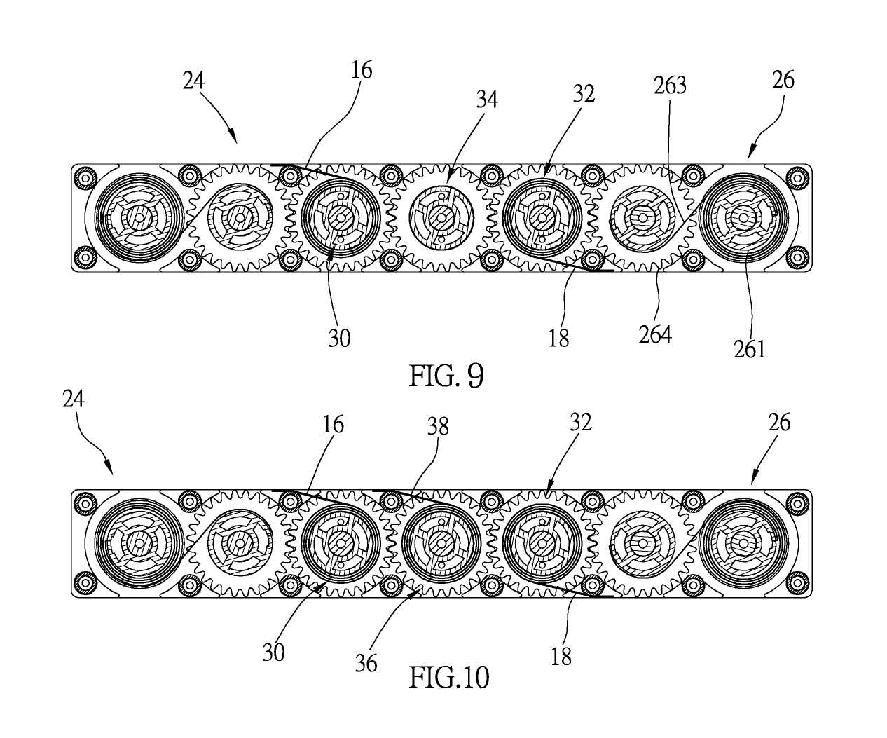

A control module of a third embodiment of the present invention is illustrated in FIG. 9. The difference between the control module of the second embodiment and that of the third embodiment is that, the control module of the third embodiment further includes an intermediate wheel 34 provided between the first reel 30 and the second reel 32, wherein the intermediate wheel 34 meshes with the first reel 30 and the second reel 32. The intermediate wheel 34 is provided for ensuring that the first reel 30 is driven by the first prestressing device 24, while the second reel 32 is driven by the second prestressing device 26. Whereby, the first reel 30 and the second reel 32 could wind up or release the lifting cords in the same rotating direction. In addition, with the intermediate wheel 34, most of the second spiral spring 263 of the second prestressing device 26 in the normal condition, winds around the first drum 261 which is not connected to the second gear 264.

A control module of a fourth embodiment of the present invention is illustrated in FIG. 10, which is adapted to be applied to a large cordless window covering with odd numbers of lifting cords. In the fourth embodiment, the control module is equipped with three lifting cords, and the control module includes the first prestressing device 24, the second prestressing device 26, the first reel 30, and the second reel 32 as disclosed in the third embodiment. The first reel 30 is wound around by the first lifting cord 16, while the second reel 32 is wound around by the second lifting cord 18. The difference is that, though the intermediate wheel 36 of the control module of the fourth embodiment is also provided between the first reel 30 and the second reel 32, it is used to wind up or release a third lifting cord 38.

Since the first prestressing device 24 and the second prestressing device 26 are symmetrically provided on two lateral sides of the reels 30, 32, the pulling force generated by the first prestressing device 24 and the second prestressing device 26 could be evenly distributed on the first reel 30, the second reel 32, and the intermediate wheel 36. Furthermore, the combined pulling force could effectively withstand the loadings of the lifting cords 16, 18, 38, which ensures that each component could rotate smoothly. Similarly, even if the cordless window covering is equipped with five lifting cords, the operation could still smooth, for the first prestressing device 24 and the second prestressing device 26 are symmetrically provided on two lateral sides.

The amount of the spiral spring winding around the drum in each prestressing device may vary depending on the rotation direction of the corresponding drum. Therefore, when the cordless window covering 100 is fully expanded, most of each of the spiral springs would wind around the corresponding drum which has a gear connected thereto. At this time, the spiral spring would exert the rotational pulling force to the drum which has no gear connected thereto, which makes part of a surface of said drum firmly abut against the relevant fixing post 20a. Such situation would hinder the smooth rotation of the drums.

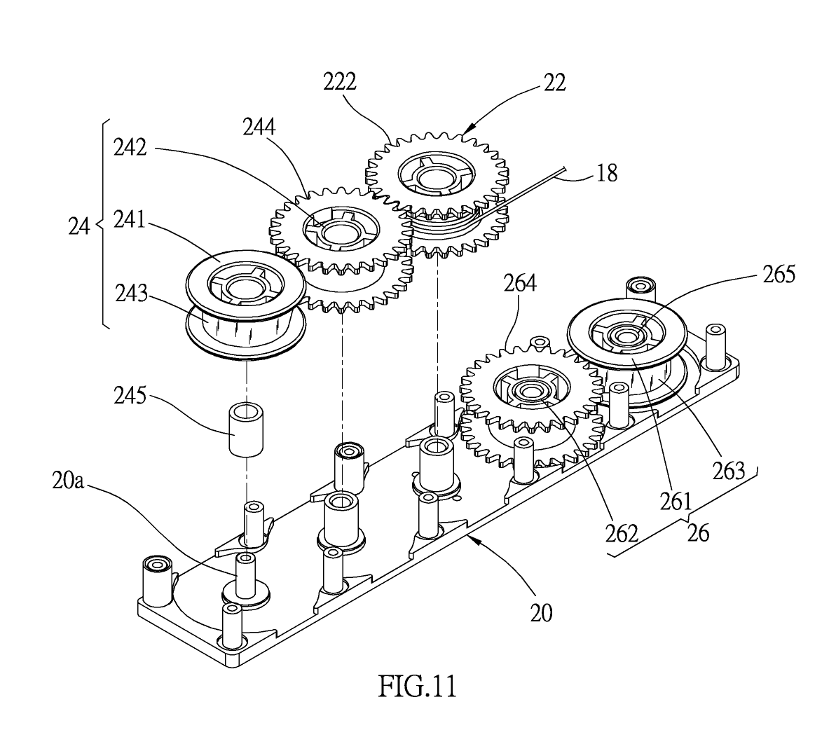

To solve this problem, each of the prestressing devices of the present invention includes a sleeve, which is provided between one of the drums and one of the fixing posts 20a. Preferably, the sleeve is provided between the drum which has no gear connected thereto and the corresponding fixing post 20a. The control module of the first embodiment is illustrated in FIG. 11 as an example, wherein the first prestressing device 24 further includes a first sleeve 245, which is rotatable, and fits between the first drum 241, which has the first gear 244 connected thereto, and one of the fixing posts 20a; the second prestressing device 26 further includes a second sleeve 265, which is rotatable, and fits between the second drum 261, which has no gear connected thereto, and one of the fixing posts 20a. Whereby, a potential defect of the first drum 241 (or the second drum 261) which may occur due to the interference of the pulling force of the spiral spring could be eliminated, which helps to ensure the drums to rotate smoothly. Said sleeves are also adapted to be used in the prestressing devices of each of the aforementioned embodiments.

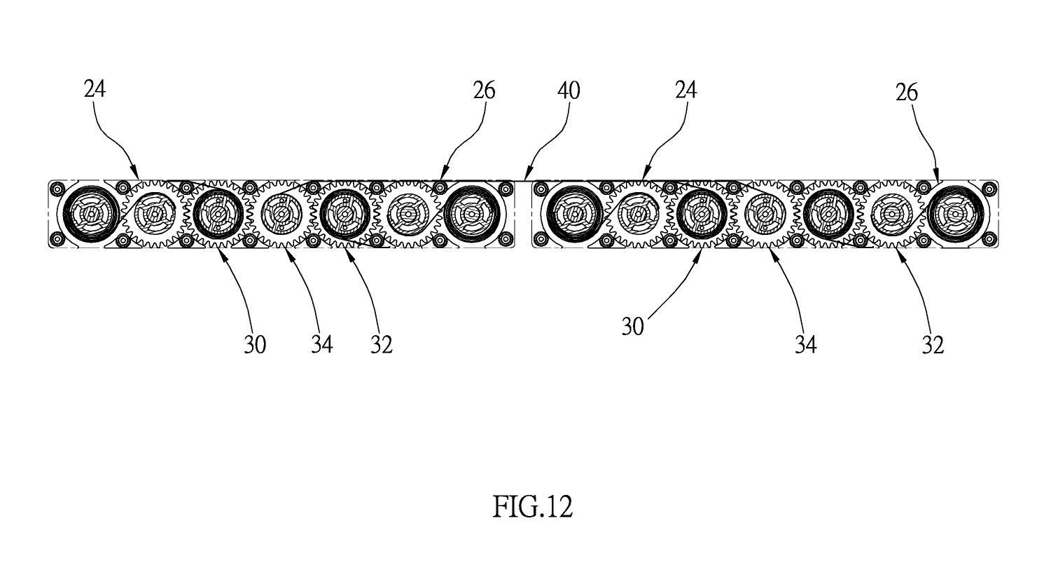

In addition, a large cordless window covering having a plurality of lifting cords could include two control modules of the present invention, which are arranged in parallel. Two control modules arranged in parallel in the headrail are illustrated in FIG. 12, wherein each of the control modules is adapted to control two lifting cords. Take the control module illustrated in FIG. 9 as an example, the two control modules are linked to rotate together through a connector provided between the control modules. In the fourth embodiment, the connector is a connecting cord 40, wherein each end of the connecting cord 40 is respectively connected to the intermediate wheel 34 of each control module. Whereby, the control modules could be driven synchronously to wind up or release the lifting cords. However, the connection relation of both ends of the connecting cord 40 is not a limitation of the present invention. As long as the connecting cord 40 is not twisted, the connecting cord 40 could be connected to the reels, the drums, or any component which is rotatable, and has a gear.

It must be pointed out that the embodiments described above are only some preferred embodiments of the present invention. All equivalent structures which employ the concepts disclosed in this specification and the appended claims should fall within the scope of the present invention.

What is claimed is:

1. A control module of a cordless window covering, comprising:
a base;
a first prestressing device provided on the base, wherein the first prestressing device comprises two first drums and a first spiral spring; each end of the first spiral spring is respectively connected to one of the first drums; one of the first drums has a first gear;
a second prestressing device provided on the base, wherein the second prestressing device comprises two second drums and a second spiral spring; each end of the second spiral spring is respectively connected to one of the second drums; one of the second drums has a second gear; and
at least one reel provided on the base, wherein the at least one reel is adapted to be wound by at least one lifting cord; the at least one reel is located between the first prestressing device and the second prestressing device, and each of the at least one reel comprises at least one intermediate gear; the first gear of the first prestressing device and the second gear of the second prestressing device are linked to rotate together through the at least one intermediate gear of the at least one reel.

2. The control module of claim 1, wherein each of the at least one reel has a spool, and one end of the spool is connected to one of the at least one intermediate gear; the spool is divided into an upper reeling segment and a lower reeling segment; the at least one lifting cord comprises a first lifting cord and a second lifting cord; one end of the first lifting cord is connected to the upper reeling segment, while one end of the second lifting cord is connected to the lower reeling segment.

3. The control module of claim 1, wherein the at least one reel comprises a first reel and a second reel; the first reel comprises a first spool and a first intermediate gear connected to one end of the first spool; the second reel comprises a second spool and a second intermediate gear connected to one end of the second spool; the at least one lifting cord comprises a first lifting cord and a second lifting cord; one end of the first lifting cord is connected to the first spool, while one end of the second lifting cord is connected to the second spool; the first gear of the first prestressing device meshes with the first intermediate gear, while the second gear of the second prestressing device meshes with the second intermediate gear, whereby the first intermediate gear and the second intermediate gear are synchronously rotatable.

4. The control module of claim 3, further comprising an intermediate wheel provided between the first reel and the second reel, wherein the intermediate wheel meshes with the first reel and the second reel, whereby the intermediate wheel, the first reel, and the second reel are linked to rotate together.

5. The control module of claim 1, wherein a plurality of fixing posts are provided on the base, which are adapted to be rotatably fitted around by the first drums, the second drums, and the at least one reel; a plurality of guiding posts are further provided on the base for determining a moving direction of each of the at least one lifting cord by being abutted against by the at least one lifting cord; the first prestressing device comprises a first sleeve, which rotatably fits between one of the first drums and one of the fixing posts;
the second prestressing device comprises a second sleeve, which rotatably fits between one of the second drums and one of the fixing posts.

6. The control module of claim 5, wherein, in a normal condition, most of the first spiral spring of the first prestressing device winds around the first drum which does not have the first gear, and the first sleeve is provided between said first drum and one of the fixing posts; also in the normal condition, most of the second spiral spring of the second prestressing device winds around the second drum which does not have the second gear, and the second sleeve is provided between said second drum and one of the fixing posts.

7. The control module of claim 1, wherein the base is long and has a certain length;
the first prestressing device and the second prestressing device are respectively located on two lateral sides of the base in parallel to a long side of the base; the first drums and the second drums are arranged substantially in parallel to the long side of the base; the first gear and the second gear respectively belong to the first drum and the second drum which are close to each other on the base, and each of which is synchronously rotatable with the relevant first drum or the relevant second drum.

8. The control module of claim 1, wherein the control module is arranged with at least one another control module; two control modules among the control module and the at least one another control module are connected through a connector; the connector is connected to any rotatable component, which has a gear, of each of said two control modules.

9. The control module of claim 8, wherein the connector is a connecting cord.
